(19) United States
(12) Patent Application Publication
(10) Pub. No.: US 2016/0203445 A1
(43) Pub. Date: Jul. 14, 2016

(54) WORK ORDER INTEGRATION AND EQUIPMENT STATUS TRACKING

(71) Applicant: Fluke Corporation, Everett, WA (US)

(72) Inventors: Bradey David Honsinger, Everett, WA (US); Jordan Schlichting, Rogers, MN (US); Jenny Lai, Everett, WA (US); John Neeley, Seattle, WA (US); Jamie Martin, Everett, WA (US); Sabrina Boler, Seattle, WA (US)

(21) Appl. No.: 14/995,079

(22) Filed: Jan. 13, 2016

Related U.S. Application Data
(60) Provisional application No. 62/103,028, filed on Jan. 13, 2015.

(51) Int. Cl. G06Q 10/00; G06F 17/24; G06T 11/20; G06Q 10/06

(52) U.S. Cl. CPC G06Q 10/20; G06Q 10/063114; G06Q 10/06393; G06F 17/243; G06T 11/206

(57) ABSTRACT

A mobile computing device establishes a first communication connection with a remotely-located server and receives at least one work order from the server. The work order indicates one or more measurement tasks associated with specified equipment to be measured and one or more required measurement tools for performing each measurement task. The work order is displayed to a user, and in response to the user bringing the mobile computing device into a communication range of a required measurement tool for at least one measurement task in the work order, the mobile computing device establishes a second communication connection with the required measurement tool and receives measurement data pertaining to the specified equipment. In response to receipt of the measurement data, the mobile computing device automatically associates the measurement data with one or more specific data entry fields of the work order pertaining to the measurement task performed.

### BACKGROUND

Measurement tools such as digital multimeter (DMM) devices, heat-sensing infrared cameras, vibration meters, and the like are used in a wide array of industrial, commercial, and residential settings to measure a variety of properties of equipment. In production facilities, plants, and factories, for example, it is critical to ensure that equipment remains operational. Interruptions in production for unexpected failure of equipment can be costly. Such facilities typically establish procedures for routine monitoring and maintenance of equipment that include using measurement tools.

For example, a technician using a handheld measurement tool may be tasked to periodically measure a property of equipment to assess the functional “health” of the equipment or to determine the presence of a fault. To perform such measurements, the technician travels to the site of the equipment, manually records data from the measurement tool, and returns to a central location to produce a report. Unfortunately, the technician may need to return multiple times to the site of the equipment to obtain the desired data. Further, analysis of measured data obtained from the equipment often requires the technician to manually enter the measured data into a computer.

In some instances, an equipment maintenance process includes obtaining readings of measurement data from multiple measurement tools at different locations, and sometimes includes obtaining measurements simultaneously or in close time proximity. Furthermore, complex calculations may be desired to be quickly performed on measured data obtained at the different locations, even when using measurement tools with limited or no functionality for storing or processing measurements over time. What is desired are systems and methods that allow guidance and coordination to be provided with respect to collecting measurements using measurement tools, and that allow measurement data to be efficiently collected and processed.

### BRIEF DESCRIPTION OF THE DRAWINGS

Various aspects and attendant advantages of the present disclosure will be more readily appreciated as the same become better understood by reference to the following detailed description, when taken in conjunction with the accompanying drawings, wherein:

FIG. 1 is a schematic diagram that illustrates an exemplary embodiment of a system according to various aspects of the present disclosure;

FIG. 2 is a flowchart that illustrates an exemplary embodiment of a method of collecting measurement data using a work order according to various aspects of the present disclosure;

FIG. 3 is a graphic display in the form of pie charts that illustrates a tracked status of equipment from which measurement data has been collected; and

FIG. 4 is a graphic display in the form of a time-series graph that illustrates a tracked status of equipment from which measurement data has been collected.

### DETAILED DESCRIPTION

In various embodiments, disclosed herein are systems and methods for capturing, storing, analyzing, and reporting data obtained from measurement devices, such as handheld measurement tools and other sensors that perform measurements of equipment, in response to work orders for performing such measurements. Such systems and methods are useful, in part, for improving the speed, accuracy, and ease of use of measurement data collected from measurement devices, especially where the measurement data is tracked over time and an operational “health” status is assigned to the equipment based on the measurement data.

As will be better understood from the following description, the term “measurement data” refers to data that is generated by a measurement device and directly or indirectly relates to or reflects a measured property of equipment, such as a device under test. In various embodiments, measurement devices may measure many types of properties, such as electrical and/or mechanical properties. Properties that may be measured by measurement devices include, for example and without limitation, electrical current, voltage, resistance, capacitance, inductance, vibration, humidity, pressure, light, time, temperature, sound, material composition, and the like. In addition, the measurement device may be a camera that is capable of taking an image of equipment. In this instance, the image would also be considered measurement data. The image could be a visible light image or non-visible light image, such as a thermal image that depicts the temperature at various points on the equipment as an image. Other non-visible images could be employed that use short wave infrared (SWIR), UV, or other portions of the electromagnetic spectrum.

Described herein, in various embodiments, is a system comprising a server and a remotely-located mobile computing device. The server includes a processor, a memory, and a communication interface. Stored in the memory are plurality of work orders. Each work order indicates one or more measurement tasks associated with specified equipment to be measured and one or more required measurement tools for performing each measurement task on the specified equipment.

The remotely-located mobile computing device communicates with the server. In various embodiments, the mobile computing device establishes a first communication connection with the server (via the respective communication interfaces) and receives at least one work order from the memory of the server.

In at least one aspect, the mobile computing device establishes a second communication connection with a required measurement tool for performing at least one measurement task in the work order. Thereafter, the mobile computing device receives from the required measurement tool measurement data pertaining to the equipment specified for the measurement task. In at least some embodiments, the mobile computing device receives the measurement data in response to establishing the second communication connection.

Furthermore, the measurement data is associated with one or more specific data entry fields of the work order pertaining to the at least one measurement task that was performed. In at least some embodiments, the measurement data is automatically associated with one or more specific data entry fields of the work order in response to receipt of the measurement data.

In some aspects, the work order received by the mobile computing device may be displayed to a user of the mobile computing device. The user may carry the mobile computing device, and in response to the user bringing the mobile computing device into a communication range of the required measurement tool, the mobile computing device establishes the second communication connection with the required measurement tool and receives the measurement data pertaining to the specified equipment.

In some aspects, the mobile computing device may transmit the received measurement data to the server via the first communication connection. The server may automatically associate the measurement data with the one or more specific data entry fields of the work order. Alternatively, or in addition, the measurement data may be communicated to a remotely-located computing device for review and designation of an operational health status for the specified equipment based on the measurement data. In other aspects, the mobile computing device may automatically associate the measurement data with the one or more specific data entry fields of the work order and transmit the work order with the associated measurement data to the server.

The mobile computing device and/or the server may automatically review the data entry fields pertaining to the measurement tasks indicated in the work order and verify whether the work order has been completed. This review of the data entry fields in the work order may occur automatically without requiring user intervention, e.g., in response to receipt of the measurement data. Alternatively, or in addition, the mobile computing device and/or the server may review the measurement data and determine whether the measurement data properly corresponds with the one or more specific data entry fields pertaining to the at least one measurement task. This review of the measurement data may occur automatically without requiring user intervention, e.g., in response to receipt of the measurement data. If an ambiguity is identified as to an association of the measurement data with one or more specific data entry fields, the mobile computing device may query a user of the mobile computing device to confirm that a correct association of the measurement data with a specific data entry field has been performed.

In various embodiments, one or more of the server, the mobile computing device, or the required measurement tool from which the measurement data was received may analyze the measurement data and automatically designate an operational health status for the specified equipment by comparing the measurement data to one or more acceptable thresholds, ranges, or data values that have been predetermined and associated with the specified equipment. Alternatively, or in addition, one or more work order metrics may be determined and reported based on data collected during the process of completing work orders. The work order metrics may include a number of work orders completed and/or a number of work order hours spent per group of equipment.

Further described herein is a mobile computing device that may include, in various embodiments, a processor, a memory, a communication interface, and/or a display. Via the communication interface, the mobile computing device may establish a first communication connection with a remotely-located server and receive at least one work order from the server. The work order indicates one or more measurement tasks that are associated with specified equipment to be measured and one or more required measurement tools for performing each measurement task on the specified equipment.

The mobile computing device may display the work order to a user via the display. The displayed work order may guide the user to carry the mobile computing device to a location within a communication range of the required measurement tool for performing at least one measurement task in the work order. Thereafter, the mobile computing device establishes a second communication connection with the required measurement tool and receives measurement data pertaining to the specified equipment. The mobile computing device may automatically establish the second communication connection in response to the user bringing the mobile computing device into the communication range of the required measurement tool.

The mobile computing device may associate the measurement data with one or more specific data entry fields of the work order pertaining to the at least one measurement task that was performed. This association of the measurement data may occur automatically without requiring user intervention, e.g., in response to receipt of the measurement data. In some aspects, the mobile computing device may automatically transmit the work order with the associated measurement data to the server from which the work order was received.

In some aspects, the mobile computing device may transmit a user identifier (e.g., as received from the user during a login procedure) to the server via the first communication connection. The user identifier identifies the user of the mobile computing device to the server, and in response, the mobile computing device may automatically receive at least one work order from the server based on the user identifier.

Alternatively, or in addition, the mobile computing device may review the specific data entry fields of the work order and verify whether the work order has been completed. This review of the data entry fields may occur automatically without requiring user intervention, e.g., in response to receipt of the measurement data. If review of the data entry fields determines that one or more measurement tasks have not been performed, the mobile computing device may automatically instruct the user, e.g., via the display, to perform the one or more measurement tasks that have not been performed.

Alternatively, or in addition, the mobile computing device may review the measurement data and determine whether the measurement data properly corresponds with the one or more specific data entry fields pertaining to the at least one measurement task. This review of the measurement data may occur automatically, e.g., in response to receipt of the measurement data. If the mobile computing device identifies an ambiguity as to an association of the measurement data with one or more specific data entry fields, the mobile computing device may query the user to confirm that a correct association of the measurement data with a specific data entry field has been performed.

Alternatively, or in addition, the mobile computing device may analyze the received measurement data and automatically designate an operational health status for the specified equipment. The analysis and designation of the operational health status may include comparing the measurement data to one or more acceptable thresholds, ranges, or data values that have been predetermined and associated with the specified equipment. In some embodiments, the mobile computing device analyzes measurement data received from multiple sensors using different sensor technologies and automatically designates the operational health status for the specified equipment based on a correlation of the measurement data analyses.

The mobile computing device may track the designated operational health status for the specified equipment for a period of time. In some aspects, the mobile computing device may provide, via the display, a graphical display of the tracked status for the specified equipment for the period of time. The graphic display may include at least a pie chart or a time-series graph illustrating changes in the operational health status of the equipment over the period of time. The equipment specified in one or more work order measurement tasks may be organized in a group or collection of equipment. In such cases, the graphic display may provide a view of the tracked status for the equipment in the group or collection of equipment for the period of time.

Alternatively, or in addition, the mobile computing device may determine and report one or more work order metrics. The one or more work order metrics may be based on data collected during the process of completing the work orders, and may include, for example, a number of work orders completed and/or a number of work order hours spent per group of equipment.

In various embodiments, the mobile computing device is a handheld measurement tool that includes circuitry configured to measure electrical or mechanical properties of equipment.

Also disclosed herein are methods that include, in various embodiments, establishing a first communication connection between a mobile computing device and a remotely-located server; receiving, at the mobile computing device via the first communication connection, at least one work order from the server, the work order indicating one or more measurement tasks associated with specified equipment to be measured and one or more required measurement tools for performing each measurement task on the specified equipment; and displaying, via a display of the mobile computing device, some or all of the at least one work order to a user of the mobile computing device. In response to the user bringing the mobile computing device into a communication range of a required measurement tool for at least one measurement task in the work order, a method may further comprise establishing a second communication connection between the mobile computing device and the required measurement tool and receiving, from the required measurement tool, measurement data pertaining to the specified equipment. In response to receiving the measurement data, the method also comprises automatically associating the measurement data with one or more specific data entry fields of the work order pertaining to the at least one measurement task that was performed.

In some aspects, the methods may further comprise automatically reviewing the measurement data and determining whether the measurement data properly corresponds with the one or more specific data entry fields pertaining to the at least one measurement task, and if an ambiguity as to an association of the measurement data with one or more specific data entry fields is identified, querying the user to confirm that a correct association of the measurement data with a specific data entry field has been performed.

Alternatively, or in addition, the methods may further comprise analyzing the received measurement data and automatically designating an operational health status for the specified equipment based on the analysis, wherein the received measurement data is analyzed by comparing the measurement data to one or more acceptable thresholds, ranges, or data values that have been predetermined and associated with the specified equipment.

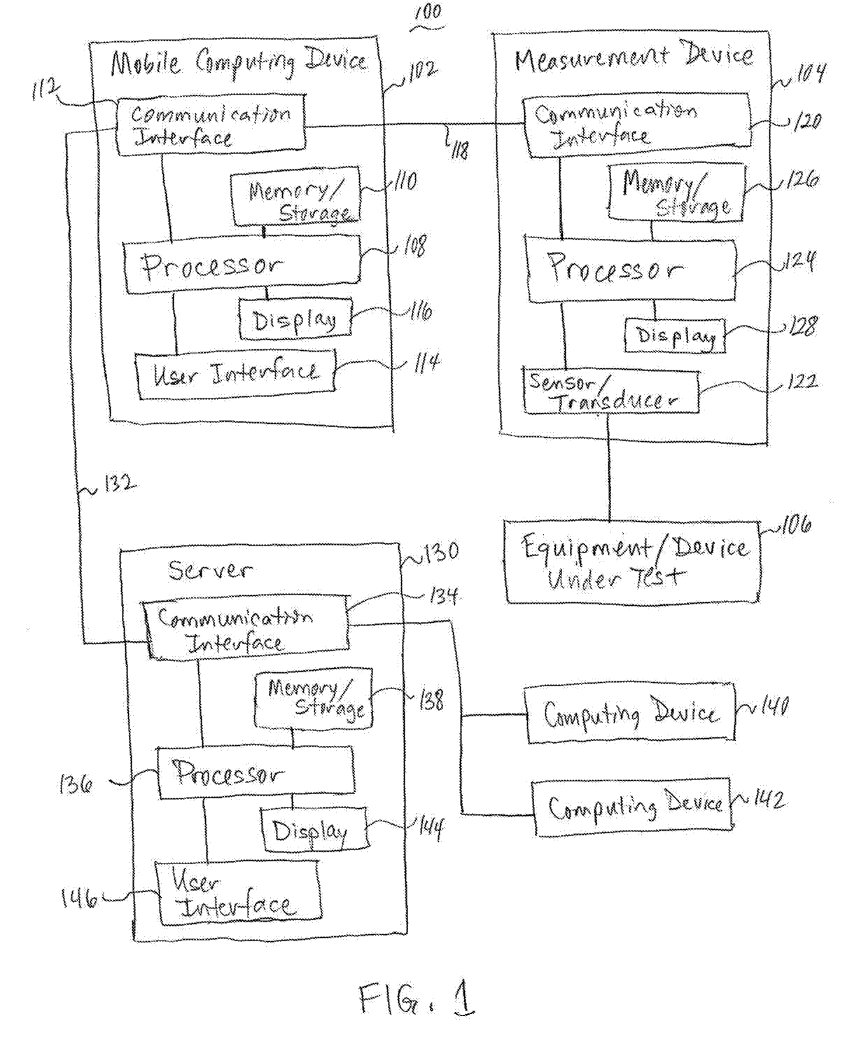

Various aspects and attendant advantages of the present disclosure are more readily appreciated in reference to the accompanying drawings. FIG. 1 is a schematic diagram that illustrates an exemplary embodiment of a system 100 according to various aspects of the present disclosure. The system 100 includes a mobile computing device 102 configured to communicate with a measurement device 104, particularly for receiving measurement data generated by the measurement device 104 based on sensed properties of equipment 106 being measured. The measurement device 104 is positioned as appropriate with respect to the equipment 106 in order to sense the desired property and generate the measurement data. In various embodiments, the equipment 106 may be considered a device under test (DUT). The mobile computing device 102 may include a wide variety of computing devices, such as (without limitation) smart handheld devices that provide cellular telephony, cellular data transmission, Bluetooth, Wi-Fi, ZigBee, and/or other types of wireless communication technology.

As illustrated, the mobile computing device 102 includes a processor 108 configured to control the operation of the mobile computing device 102. The processor 108 may execute one or more applications, for example, that provide processes for collecting, processing, storing, and transmitting measurement data obtained from the measurement device 104. The one or more applications may comprise computer-executable instructions stored in a memory/storage device 110 and accessed as needed by the processor 108. The memory/storage device 110 may include any form of non-transitory computer readable storage media, such as read only memory, random access memory, hard drives, disks, flash memory, and the like.

The processor 108 is further communicatively coupled to a communication interface 112, a user interface 114, and a display 116. As will be appreciated from the description herein, the mobile computing device 102 may include additional elements beyond those illustrated and/or elements that are presently shown in FIG. 1 may optionally be excluded from the device. As to the illustrated embodiment, the user interface 114 is generally configured to allow a user to input instructions with regard to processes being performed by the mobile computing device 102. The display 116 is generally configured to provide feedback to an operator of the mobile computing device 102, including graphical displays of measurement data obtained from the measurement device 104 and/or other data or information derived from or pertaining to the collected measurement data.

The mobile computing device 102 is capable of communicating with the measurement device 104 by establishing a communication connection 118 between the communication interface 112 of the mobile computing device and a communication interface 120 of the measurement device. The communication connection 118 may be a persistent or temporary connection, as appropriate, to receive measurement data from the measurement device 104. The communication connection 118 may be a wireless communication connection using one or more wireless protocols such as provided by one or more of the wireless communication technologies mentioned earlier herein. Alternatively, the communication connection 118 may be a wired connection that uses one or more wired communication protocols, such as USB, Ethernet, and the like.

In various embodiments, the measurement device 104 may be, for example, a measurement tool such as a digital multimeter (DMM), a network tester, an infrared or thermal imaging camera, an environmental test device such as a vibration tester or pressure tester, or so forth. Generally, the measurement device 104 includes a sensor 122 that is positioned with respect to the equipment 106 being measured so that the sensor 122 can measure a desired property of the equipment 106. For example, the sensor 122 may be a transducer capable of measuring a physical property of the equipment 106 and providing measurement signals based thereon to a processor 124. The processor 124 processes the measurement signals to produce measurement data that, in some embodiments, may be stored in a memory/storage device 126. In some embodiments, the measurement device 104 is a single purpose device that measures a single property or characteristic, while in other embodiments, the measurement device 104 is a multi-purpose device capable of measuring multiple, different properties or characteristics of the equipment 106.

As shown in FIG. 1, the measurement device 104 operates under control of the processor 124 configured to execute instructions that may be stored in the memory/storage device 126. The memory/storage device 126 may also be used by the processor 124 to store measurement data based on signals received from the sensor 122. Optionally, the measurement device 104 may further include a display 128 that provides information, measurement data, and/or feedback in visual or audible form that is useful to an operator of the measurement device 104.

As will be discussed in greater detail below, the mobile computing device 102 is configured to receive and process measurement data, and further transmit the measurement data to a server 130. Communication between the mobile computing device 102 and the server 130 may be provided by a communication connection 132 established between the communication interface 112 of the mobile computing device 102 and a communication interface 134 of the server 130. As with the communication connection 118, the communication connection 132 may be a wired or wireless connection and may include one or more intervening network devices (e.g., Internet gateways and communication links) that enable communication between the respective communication interfaces 112, 134. The server 130 may also be accessible to other computing devices to share information, such as measurement data, and provide services such as providing a dashboard showing the status of measured equipment.

The server 130 includes a processor 136 coupled to the communication interface 134 to receive and process information, such as measurement data, received by the communication interface 134. The processor 136 may operate in accordance with executable instructions stored in a memory/storage device 138. Furthermore, information and data processed by the processor 136 may be stored in the memory/storage device 138 for later transmission back to the mobile computing device 102 and/or to one or more external computing devices 140, 142 communicatively coupled to the communication interface 134.

To facilitate operation of the server 130, the server 130 may further include an optional display 144 and/or user interface 146 that are usable by an operator of the server 130. In some embodiments, the server 130 may appear to the mobile computing device 102, the measurement device 104, and/or the external computing devices 140, 142, as a “cloud” device where measurement data and equipment status information is received, stored, processed, and/or made available for analysis and further processing.

The server 130 may further include, or have access to, work orders that help guide an operator of the mobile computing device 102 and/or the measurement device 104 in collecting desired measurement data. Work orders are typically created to provide instructions, procedures, and/or tasks for measuring properties of equipment and organizing the measurement data as obtained. Generally, a work order identifies items of equipment 106 and indicates a series of measurements to be completed. In accordance with the present disclosure, work orders may also indicate one or more required tools for performing the desired measurements. A work order creation tool may be provided in which one or more input mechanisms such as checkboxes are shown with a listing of supported tools that enable the measurement data to be obtained. When a measurement task is defined in the work order creation tool and associated with particular equipment and desired measurement tools, the measurement task is added to the work order. A work order creation tool thus allows for customization of a work order to specify the equipment, the desired measurements, and the required tools for obtaining the measurement data. Work orders may be stored, for example, in the memory/storage device 138 and transmitted by the communication interface 134 to the mobile computing device 102 via the communication connection 132.

In accordance with various embodiments described herein, measurement data received from the measurement device 104 by the mobile computing device 102 in accordance with one or more work orders may be stored in association with the work orders in the memory/storage device 110. For example, a work order may include various fields associated with specific equipment, measurement attributes, and required tools for obtaining measurement data. Periodically or continuously, progress information concerning measurement tasks indicated by a work order as completed may be transmitted from the mobile computing device 102 to the server 130 for processing and/or storage in the memory/storage device 138. The server 130 is thus able to track the progress of work orders that are currently in process.

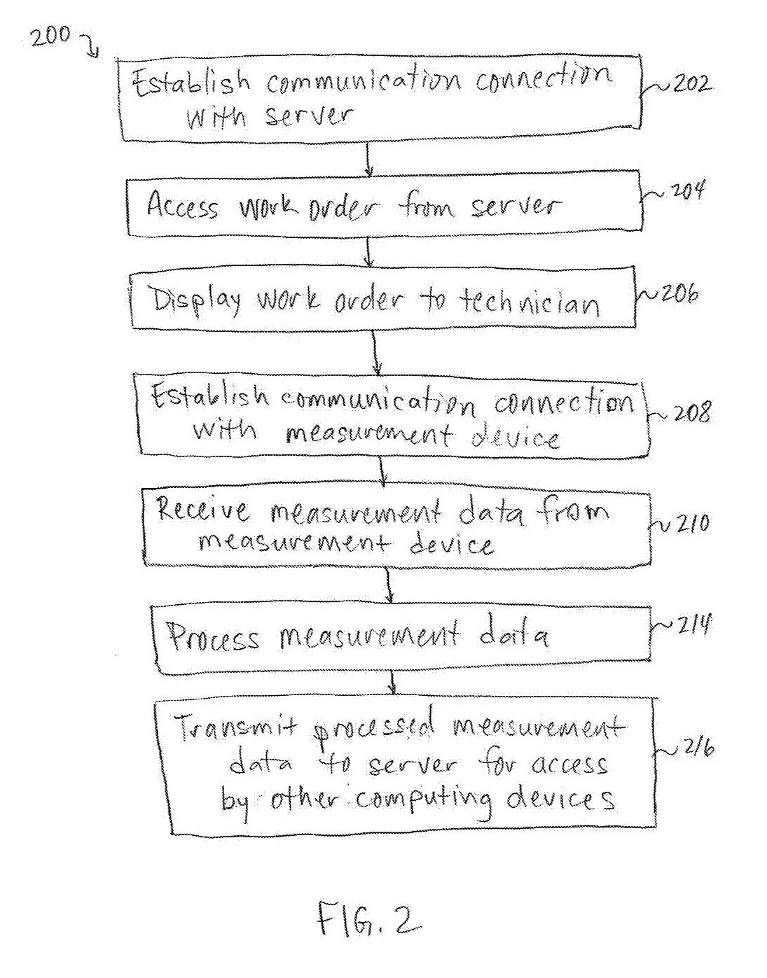

FIG. 2 is a flowchart illustrating an exemplary embodiment of a method 200 for a mobile computing device collecting measurement data using a work order according to various aspects of the present disclosure. The method 200 begins at block 202 with the mobile computing device 102 establishing a communication connection 132 with the server 130. At block 204, the mobile computing device 102 accesses a work order that has been stored in the memory/storage device 138. The mobile computing device 102 may access the work order by request, or alternatively, the server 130 may be configured to automatically push one or more work orders from the memory/storage device 138 to mobile computing device 102. The mobile computing device 102 may be associated with a particular technician (e.g., by having the technician logged in to the measurement application running on the device), and work orders designated for the particular technician can be automatically provided by the server 130 to the mobile computing device 102 once the communication connection 132 is established.

Upon receipt of the work order, the processor 108 of the mobile computing device 102 analyzes the procedures, instructions, and/or tasks indicated by the work order, and configures a display of the work order (block 206) to a technician operating the mobile computing device 102. As may be appropriate, the technician is guided by the work order to move into communication proximity with one or more measurement devices 104 from which measurement data is to be obtained.

At block 208, the mobile computing device 102 establishes a communication connection 118 with a desired measurement device 104. The measurement device 104 is positioned with respect to equipment, such as a DUT 106, and the sensor 122 of the measurement device generates signals representative of one or more measured properties of the DUT 106. The processor 124 produces measurement data based on the signals received from the sensor 122, and communicates the measurement data via the interface 120 to the mobile computing device 102. At block 210, the mobile computing device 102 receives the measurement data from the measurement device, and at block 214, the mobile computing device 102 processes the measurement data.

The processing of measurement data at block 214 may include a wide variety of computations, transformations, and/or analysis of the measurement data to produce processed measurement data that is useful to assess the operational “health” of the DUT 106. Importantly, in various embodiments, the mobile computing device 102 is configured to associate measurement data with the DUT 106 without any action required by a technician operating the mobile computing device 102. The measurement data may further be associated with the work order, also without any action required by a technician operating the mobile computing device 102. Accordingly, upon receipt of a work order, a technician is able to bring the mobile computing device 102 into communication with one or more measurement devices 104 and efficiently receive and forward measurement data regarding the DUT 106 in satisfaction of the work order. As indicated at block 216 in FIG. 2, the measurement data received by the mobile computing device 102 and associated with the work order and the DUT 106 is further communicated to the server 130.

In some embodiments, the mobile computing device 102 is configured to associate received measurement data with specific data entry fields of the work order that pertain to the measurement data and the measurement task performed. In other embodiments, the mobile computing device 102 may simply forward the measurement data to the server 130 whereupon the server 130 associates the received measurement data with specific data entry fields of the work order. The specific data entry fields of the work order will have the measurement task and required tool already associated therewith such that association of the measurement data with a corresponding data entry field further automatically associates the measurement data with the measurement task and tool used to obtain the measurement data.

In instances where a technician is operating the mobile computing device 102 in an environment where the mobile computing device is unable to maintain a communication connection 132 with the server 130, the technician may continue obtaining measurement data from measurement devices 104 as directed by a work order downloaded to the mobile computing device 102. In embodiments where the mobile computing device 102 does not perform actions to associate received measurement data with specific data entry fields of the work order, the mobile computing device 102 may simply store the received measurement data and, when the communication connection 132 is established, the mobile computing device 102 may provide a batch of measurement data to the server 130 for association with specific data entry fields of the work order. The server 130 analyzes the received measurement data and matches the measurement data with the corresponding data entry fields. In circumstances where there is ambiguity as to which measurement data belongs in which data entry field, the server 130 may cause the mobile computing device 102 to query the technician and confirm that a correct association of the measurement data with the work order has been performed.

In some embodiments, the mobile computing device 102 and/or the server 130 is configured to review the work order and the corresponding received measurement data to verify whether the work order is completed. In some instances, a work order verification process may automatically occur following receipt of an indication from a technician that the work order is completed. In other instances, the work order verification process may automatically occur while measurement data is being received so that, when the work order is completed, the technician may be promptly notified. In instances where a batch of measurement data is received, the mobile computing device 102 and/or the server 130 may automatically perform the work order verification process during or after the matching of the measurement data with corresponding data fields in the work order.

If the work order verification process determines that one or more data fields in the work order are missing measurement data, an automatic notification may be sent to the technician (e.g., displayed on the display 116, 128, or 136) to instruct the technician to obtain the missing measurement data. In this manner, the work order verification process can verify that all measurement data required by the work order is obtained while the technician is still out in the field.

In some embodiments, the work order verification process may also analyze the content of the measurement data being captured and determine whether incorrect data is being captured. For example, if the type of measurement data being captured does not correspond with the type of measurement data that is expected for the measurement task, the word order verification process may warn the user of the mobile computing device that incorrect data may have been captured. If the received measurement data does not properly correspond with one or more data entry fields in the work order, the mobile computing device 102 and/or the server 130 may notify the technician so that proper measurement data may be obtained. The processed measurement data at the server 130 may thereafter be accessible to other computing devices, such as external computing devices 140, 142.

For example, the computing device 140 may be a supervisory station for an industrial process in which the measurement device 104, among other measurement devices, is operating. A supervisor using the computing device 140 may access and analyze measurement data as it is received by the server 130 from one or more technicians operating one or more mobile computing devices 102 in accordance with one or more work orders provided by the server 130.

In another example, the computing device 142 may be operated by a remote expert who is qualified to analyze and comment on measurement data pertaining to equipment, as received by the server 130. In this example, the expert may be able to review the measurement data and designate a status of the equipment based on the measurement data observed. In various embodiments, the expert may assign a green colored status, for example, indicating that the equipment is in good maintenance condition, while in other instances, the expert may assign a yellow or red status to equipment needing further attention or equipment that has failed.

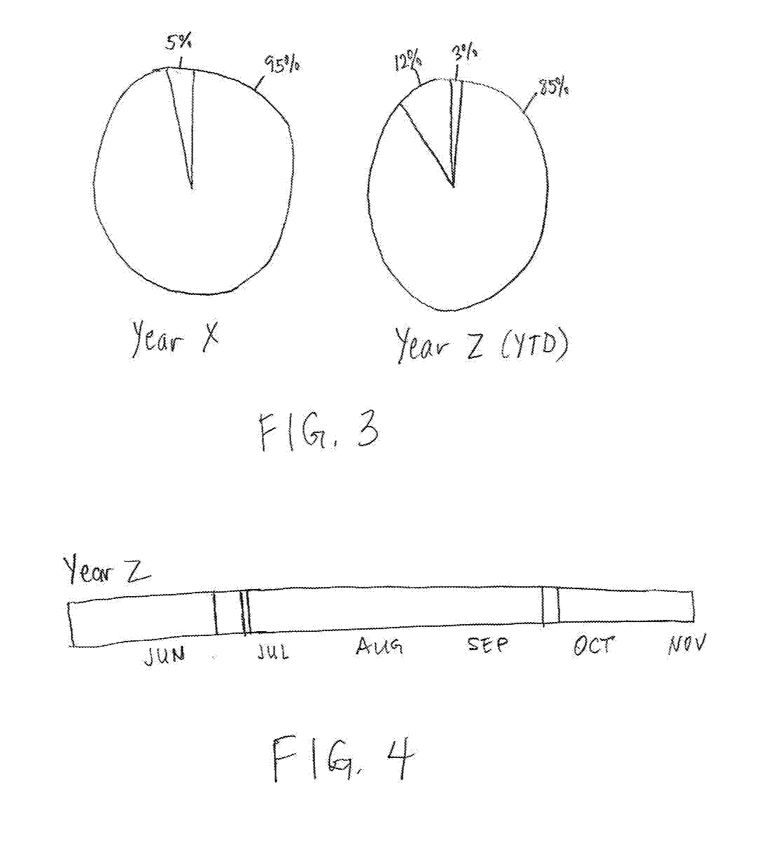

As an alternative to manual assignment of equipment status as described above, one or more of the server 130, the mobile computing device 102, and/or the measurement device 104 may be configured to analyze the measurement data as it is generated or received, and automatically designate a status for the equipment by comparing the measurement data to one or more acceptable thresholds, ranges, or data values that have been predetermined and associated with the equipment. For example, in some embodiments, measurement data obtained from multiple sensors using different sensor technologies may be coupled with unique thresholds for each sensor technology that, when combined for a piece of equipment under inspection, provide a more thorough and accurate characterization of the operational health of the piece of equipment. By way of a few examples, vibration data sensed from an electric motor, as compared to one or more threshold values, may be combined with thermal imaging data sensed by a thermal imager, or power quality measurements of an electric motor, as compared to one or more threshold values, may be combined with thermal imaging measurements (images) to provide a more comprehensive analysis of an electric motor. By correlating two or more unique measurements from sensors using complimentary technologies at the time of inspection, an improved characterization of equipment health can be obtained. Automated designation of equipment status may further accelerate an efficient analysis of the operational health of the equipment as will be described with respect to FIGS. 3 and 4.

FIG. 3 is a graphic display that illustrates a tracked status of equipment from which measurement data has been collected. In particular, FIG. 3 illustrates two pie charts that correspond to two periods of time identified as “Year X” and “Year Z (YTD).” In this example, Year X signifies a completed year over which measurement data has been collected from one or more items of equipment, while Year Z (YTD) signifies a partial year-to-date collection of measurement data for particular equipment.

Graphic displays provided by embodiments of the present disclosure enable owners, operators, and other parties interested in tracking the status of equipment to quickly and efficiently observe the operational health of the equipment, as reflected by measurement data generated from sensing one or more properties of the equipment. The status of the equipment may be manually assigned, or assigned automatically by one or more computing processes, as described above. Such graphic displays are particularly useful when providing a status summary to interested parties.

For example, the pie chart for Year X indicates that the measured equipment was in good operational health for 95% of the year. However, for 5% of the year, the measured equipment was designated as being in danger of failure, and thus needing further attention. Turning to the year-to-date status information for Year Z, the pie chart indicates that the measured equipment was in good operational health for 85% of the time to date, while the equipment was designated as being in danger of failure for 12% of the time, and in a state of failure for 3% of the time. An advantage of the pie charts shown in FIG. 3 is that the status of the equipment can be quickly summarized for a desired period of time.

FIG. 4 illustrates another graphic display, in this instance in the form of a time-series graph, which depicts a tracked status of equipment for Year Z. As illustrated, the time-series graph shows a period of time in June when the equipment was a good operational health, followed by a smaller period in which the equipment was designated as being in danger of failure. Thereafter, at the beginning of July, a short period is shown in which the equipment was designated as failed. Presumably due to corrective action, the status of the equipment for the balance of July, August, and September is shown as being in good operational health. Another period in which the equipment was designated as being in danger of failure appears toward the end of September, after which the issues with the equipment were remedied, thus resulting in a status of good operational health for the balance of October and November. An advantage of a time-series graph as shown in FIG. 4 is that the graph quickly illustrates how the status of the equipment has changed over a period of time. Accordingly, interested parties are able to quickly observe and understand the operational status of the equipment being monitored by one or more measurement devices.

It should be appreciated and understood that the graphic displays shown in FIGS. 3 and 4 may be generated with respect to individual items of equipment. Alternatively, the graphic displays may be generated with respect to groups or collections of equipment, e.g., according to particular industrial processes, types of equipment, locations of equipment, or any other category or grouping that may associate multiple items of equipment together. Accordingly, interested parties are able to quickly observe and understand the operational status of single items of equipment, as well as entire operations comprised of multiple items of equipment.

In some embodiments, an automated status reporting tool, such as a dashboard, may be implemented to allow interested parties to quickly observe the operational health of desired equipment. The status reporting tool may access one or more predefined profiles indicating the desired information for the dashboard, and access processed measurement data and/or status designations in the memory/storage device to enable efficient display of information showing the operational health of the equipment. The one or more profiles may be modified as desired and stored in the memory/storage device in order to produce relevant status reports.

In some embodiments, items of equipment may be organized hierarchically, e.g., in a tree structure. Designation of a particular root, branch, or leaf of the tree may identify the desired equipment or collection of equipment for which measurement data, equipment status designations, processing measurements, and/or work order metrics may be grouped and displayed, for example as shown in FIGS. 3 and 4. A variety of work order metrics may be determined and reported based on data collected during the process of completing work orders. For example, the mobile computing device 102 may supply information to the server 130 from which the number of work orders completed and/or work order hours spent per group of equipment can be determined. By enabling different designations of equipment or collections of equipment for reporting, various comparisons of measurement data and/or work order metrics within a group of equipment (such as a trending graph for all motors in a group of equipment) or comparisons of measurement data or work order metrics between two or more groups of equipment (such as equipment in a first production line versus equipment in a second production line) may be prepared and displayed for use by interested parties.

While embodiments of systems and methods have been illustrated and described in the foregoing description, it will be appreciated that various changes can be made therein without departing from the spirit and scope of the present disclosure. For example, while embodiments of the mobile computing device 102 have been described in the context of a smart device executing one or more programmed applications, other embodiments of the mobile computing device may include a handheld measurement tool that is additionally capable of measuring properties of equipment. The measurement devices, as indicated earlier, may include handheld measurement tools as well as multipurpose and single use sensors that are positioned relative to equipment to be measured. Furthermore, the communication interface 120 of the measurement devices 104 may be configured for wired or wireless communication directly with the server 130 for direct communication of measurement data to the server 130. In such instances, for example, the mobile computing device 102 may be used to obtain one or more work orders and initiate measurements of equipment, with an understanding that the measurement devices 104 are providing measurement data directly to the server 130. In some embodiments, the server 130 may transmit confirmation of receipt of the measurement data to the mobile computing device 102 to inform the technician of the progress attained in completing the work order.

Furthermore, the present disclosure contemplates computer-executable instructions that, in response to execution by one or more computing devices, cause the one or more computing devices to perform processes as described herein. Such computer-executable instructions be stored in a non-transitory computer-readable medium that is accessible to the one or more computing devices. Moreover, it should be understood that rearrangement of structure or steps in the devices or processes described herein that yield similar results are considered within the scope of the present disclosure. Accordingly, the scope of the present disclosure is not constrained by the precise forms that are illustrated and described herein.

What is claimed is:

1. A system comprising:
a server that includes a processor, a memory, and a communication interface, wherein a plurality of work orders are stored in the memory, each work order indicating one or more measurement tasks associated with specified equipment to be measured and one or more required measurement tools for performing each measurement task on the specified equipment; and
a remotely-located mobile computing device in communication with the server, wherein a communication interface of the mobile computing device establishes a first communication connection with the communication interface of the server and receives at least one work order from the memory of the server,
wherein, in response to the mobile computing device establishing a second communication connection with a required measurement tool for performing at least one measurement task in the work order, the mobile computing device receives measurement data pertaining to the specified equipment from the required measurement tool, and
wherein, in response to receipt of the measurement data, the measurement data is automatically associated with one or more specific data entry fields of the work order pertaining to the at least one measurement task that was performed.

2. The system of claim 1, wherein the at least one work order received by the mobile computing device is displayed to a user of the mobile computing device, and in response to the user bringing the mobile computing device into a communication range of the required measurement tool for performing the at least one measurement task, the mobile computing device establishes the second communication connection with the required measurement tool and receives the measurement data pertaining to the specified equipment.

3. The system of claim 1, wherein, via the first communication connection, the mobile computing device transmits the received measurement data to the server, and the server automatically associates the measurement data with the one or more specific data entry fields of the work order.

4. The system of claim 3, wherein the measurement data is further communicated to a remotely-located computing device for review and designation of an operational health status for the specified equipment based on the measurement data.

5. The system of claim 1, wherein the mobile computing device automatically associates the measurement data with the one or more specific data entry fields of the work order and transmits the work order with the associated measurement data to the server.

6. The system of claim 1, wherein in response to receipt of the measurement data, the mobile computing device and/or the server automatically reviews the data entry fields pertaining to the measurement tasks indicated in the work order and verifies whether the work order has been completed.

7. The system of claim 1, wherein in response to receipt of the measurement data, the mobile computing device and/or the server automatically reviews the measurement data and determines whether the measurement data properly corresponds with the one or more specific data entry fields pertaining to the at least one measurement task.

8. The system of claim 7, wherein if an ambiguity is identified as to an association of the measurement data with one or more specific data entry fields, the mobile computing device queries a user of the mobile computing device to confirm that a correct association of the measurement data with a specific data entry field has been performed.

9. The system of claim 1, wherein one or more of the server, the mobile computing device, or the required measurement tool from which the measurement data was received analyzes the measurement data and automatically designates an operational health status for the specified equipment by comparing the measurement data to one or more acceptable thresholds, ranges, or data values that have been predetermined and associated with the specified equipment.

10. The system of claim 1, wherein one or more work order metrics are determined and reported based on data collected during the process of completing work orders, the work order metrics including a number of work orders completed and/or a number of work order hours spent per group of equipment.

11. A mobile computing device comprising:
a processor, a memory, a communication interface, and a display;
wherein, via the communication interface, the mobile computing device establishes a first communication connection with a remotely-located server and receives at least one work order from the server, the work order indicating one or more measurement tasks associated with specified equipment to be measured and one or more required measurement tools for performing each measurement task on the specified equipment;
wherein the mobile computing device displays the at least one work order to a user of the mobile computing device via the display, and in response to the user bringing the mobile computing device into a communication range of a required measurement tool for at least one measurement task in the work order, the mobile computing device establishes a second communication connection with the required measurement tool and receives measurement data pertaining to the specified equipment; and
wherein, in response to receipt of the measurement data, the mobile computing device automatically associates the measurement data with one or more specific data entry fields of the work order pertaining to the at least one measurement task that was performed.

12. The mobile computing device of claim 11, wherein the display of the at least one work order to the user of the mobile computing device further guides the user to a location within the communication range of the required measurement tool.

13. The mobile computing device of claim 11, wherein the mobile computing device automatically transmits the work order with the associated measurement data to the server from which the work order was received.

14. The mobile computing device of claim 11, wherein the mobile computing device transmits a user identifier that identifies the user of the mobile computing device to the server via the first communication connection, and in response, the mobile computing device automatically receives the at least one work order from the server based on the user identifier.

15. The mobile computing device of claim 11, wherein in response to receipt of the measurement data, the mobile computing device automatically reviews the specific data entry fields of the work order and verifies whether the work order has been completed.

16. The mobile computing device of claim 15, wherein if review of the data entry fields determines that one or more measurement tasks have not been performed, the mobile computing device automatically instructs the user, via the display, to perform the one or more measurement tasks that have not been performed.

17. The mobile computing device of claim 11, wherein in response to receipt of the measurement data, the mobile computing device automatically reviews the measurement data and determines whether the measurement data properly corresponds with the one or more specific data entry fields pertaining to the at least one measurement task.

18. The mobile computing device of claim 17, wherein if the mobile computing device identifies an ambiguity as to an association of the measurement data with one or more specific data entry fields, the mobile computing device queries the user to confirm that a correct association of the measurement data with a specific data entry field has been performed.

19. The mobile computing device of claim 11, wherein the mobile computing device analyzes the received measurement data and automatically designates an operational health status for the specified equipment by comparing the measurement data to one or more acceptable thresholds, ranges, or data values that have been predetermined and associated with the specified equipment.

20. The mobile computing device of claim 19, wherein the mobile computing device analyzes measurement data received from multiple sensors using different sensor technologies and automatically designates the operational health status for the specified equipment based on a correlation of the measurement data analyses.

21. The mobile computing device of claim 19, wherein the mobile computing device tracks the designated operational health status for the specified equipment for a period of time, and wherein, via the display, the mobile computing device provides a graphical display of the tracked status for the specified equipment for the period of time.

22. The mobile computing device of claim 21, wherein the graphic display includes at least a pie chart or a time-series graph illustrating changes in the operational health status of the equipment over the period of time.

23. The mobile computing device of claim 21, wherein the specified equipment is organized in a group or collection of equipment, and the graphic display provides a view of the tracked status for the equipment in the group or collection of equipment for the period of time.

24. The mobile computing device of claim 11, wherein the mobile computing device determines and reports one or more work order metrics based on data collected during the process of completing work orders, the work order metrics including a number of work orders completed and/or a number of work order hours spent per group of equipment.

25. The mobile computing device of claim 11, wherein the mobile computing device is a handheld measurement tool that includes circuitry configured to measure electrical or mechanical properties of equipment.

26. A method, comprising:
establishing a first communication connection between a mobile computing device and a remotely-located server;
receiving, at the mobile computing device via the first communication connection, at least one work order from the server, the work order indicating two or more measurement tasks associated with specified equipment to be measured and one or more required measurement tools for performing each measurement task on the specified equipment;
displaying, via a display of the mobile computing device, some or all of the at least one work order to a user of the mobile computing device;
in response to the user bringing the mobile computing device into a communication range of a required measurement tool for at least one measurement task in the work order, establishing a second communication connection between the mobile computing device and the required measurement tool and receiving, from the required measurement tool, measurement data pertaining to the specified equipment; and
in response to receiving the measurement data, automatically associating the measurement data with one or more specific data entry fields of the work order pertaining to the at least one measurement task that was performed.

27. The method of claim 26, further comprising:
automatically reviewing the measurement data and determining whether the measurement data properly corresponds with the one or more specific data entry fields pertaining to the at least one measurement task; and
if an ambiguity as to an association of the measurement data with one or more specific data entry fields is identified, querying the user to confirm that a correct association of the measurement data with a specific data entry field has been performed.

28. The method of claim 26, further comprising:
analyzing the received measurement data; and
automatically designating an operational health status for the specified equipment based on the analysis,
wherein the received measurement data is analyzed by comparing the measurement data to one or more acceptable thresholds, ranges, or data values that have been predetermined and associated with the specified equipment.
